(19) United States
(12) Patent Application Publication
(10) Pub. No.: US 2006/0292377 A1
(43) Pub. Date: Dec. 28, 2006

(54) Adhesive attachment of a first member to a second member

(75) Inventors: Roger James Hoffman, Prior Lake, MN (US); David Daniel Backlund, Prior Lake, MN (US); Dennis Qunito Cruz, Longmont, CO (US); Paul Wayne McLaughlin, Longmont, CO (US)

Correspondence Address: Derek J. Berger;Seagate Technology LLC, Intellectual Property - COL2LGL, 389 Disc Drive, Longmont, CO, 80503, US

(73) Assignee: Seagate Tecnology LLC

(21) Appl. No.: 11/168,805

(22) Filed: Jun. 28, 2005

(51) Int. Cl. B32B 37/12; B32B 38/00; B32B 27/38

(52) U.S. Cl. 428/414; 156/247; 156/344; 156/330; 156/275.7

(57) ABSTRACT

Apparatus and method for adhesively attaching a first member to a second member, such as components of a data storage device. Preferably, an adhesive is applied to the first member and exposed to ultraviolet light. The second member is placed onto the adhesive, and heat is applied to finalize curing. The adhesive is subsequently cooled to a temperature below a glass transition temperature (Tg) of the adhesive to detach the first and second members. Respective mating surfaces of the first and second members are preferably provided with different adhesive coupling characteristics, such as by provision of a surface adhesive promotor or a micro-texturized pattern to only one member. In this way, upon detachment of the first and second members, substantially all of the adhesive is removed from the other member. A filler material further establishes adhesive thickness and enhances structural unity of the adhesive during detachment of the respective members.

### FIELD OF THE INVENTION

The claimed invention relates generally to the field of adhesives and more particularly, but not by way of limitation, to an apparatus and method for adhesively attaching a first member to a second member, such as components in a data storage device.

### BACKGROUND

Adhesives are used in a variety of applications to attach a first member to a second member. For example, designers have proposed various configurations whereby adhesives are used during the manufacture of data storage devices, such as in the attachment of a suspension assembly (flexure) to a rigid actuator arm, the flexure being configured to support a data transducer adjacent a data storage medium (disc).

While operable, there are a number of limitations associated with the use of adhesives in these and other applications. Thermal set adhesives can provide very strong adhesive bonds, but can require excessively high temperatures and off-line operations and fixturing.

Ultraviolet (UV) cured adhesives may not provide sufficiently strong adhesive bonds, and may also require off-line operations to establish a UV cure. Shadowing effects, whereby the UV light is blocked or otherwise prevented from reaching the adhesive due to component interference, can also limit the ability to establish the requisite bond strength.

There are also situations where it may be desirable to subsequently detach the first and second members, and these and other prior art approaches may not adequately control the distribution of residual adhesive on the respective members.

Accordingly, there is a continual need for improvements in the art whereby respective members can be adhesively attached and subsequently detached in a controlled manner.

### SUMMARY OF THE INVENTION

Preferred embodiments of the present invention are generally directed to an apparatus and method for attaching a first member and a second member, such as components of a data storage device.

An adhesive is used to attach the first and second members, preferably by applying the adhesive to the first member, exposing the adhesive to ultraviolet light to initiate curing of the adhesive, placing the second member onto the adhesive, and applying heat to the adhesive to finalize curing.

The adhesive is subsequently cooled to a temperature below a glass transition temperature (Tg) of the adhesive to detach the first and second members. This cooling places the adhesive in a substantially brittle condition, allowing the use of a relatively small mechanical force to detach the members.

Respective mating surfaces of the first and second members are preferably provided with different adhesive coupling characteristics, such as by the application of a surface adhesive promotor or a micro-texturized pattern to only a selected one of the members. Alternatively, or additionally, filler material is preferably added to the adhesive to control adhesive thickness and enhance structural unity of the adhesive.

In this way, upon detachment of the first and second members, substantially all of the adhesive is preferably retained on the selected member, and substantially all of the adhesive is removed from the remaining member.

While any number of applications are contemplated, in a preferred embodiment the first and second members comprise an actuator arm and a suspension used to support a transducer adjacent a data storage medium. In an alternative preferred embodiment, the first and second members comprise a suspension and a transducer.

These and various other features and advantages which characterize the claimed invention will become apparent upon reading the following detailed description and upon reviewing the associated drawings.

### BRIEF DESCRIPTION OF THE DRAWINGS

FIG. 1 is an exploded view of a particular construction for a data storage device accordance with preferred embodiments of the present invention.

FIG. 2 shows a suspension (flexure) and a portion of an actuator arm of the data storage device of FIG. 1.

FIG. 3 provides a flow chart for an ASSEMBLY ROUTINE, illustrative of steps carried out in accordance with preferred embodiments of the present invention to attach a first member to a second member, such as the components of FIG. 2.

FIG. 4 is a sequence of elevational, cross-sectional representations of the first and second members to further illustrate the preferred sequence of FIG. 3.

FIG. 5 is a flow chart for a DISASSEMBLY ROUTINE, illustrative of steps carried out in accordance with preferred embodiments of the present invention to subsequently detach the first and second members of FIG. 3.

FIG. 6 is a sequence of elevational, cross-sectional representations of the first and second members to further illustrate the preferred sequence of FIG. 5.

FIG. 7 provides an alternative embodiment for the first and second members whereby one of the members is provided with a surface adhesive promotor, preferably comprising a silane agent.

FIG. 8 provides another alternative embodiment for the first and second members, whereby one of the members is provided with a micro-texturized pattern to enhance adhesion of the adhesive.

FIG. 9 provides another alternative embodiment wherein a filler material is added to the adhesive to generally control thickness and enhance structural unity of the adhesive.

### DETAILED DESCRIPTION

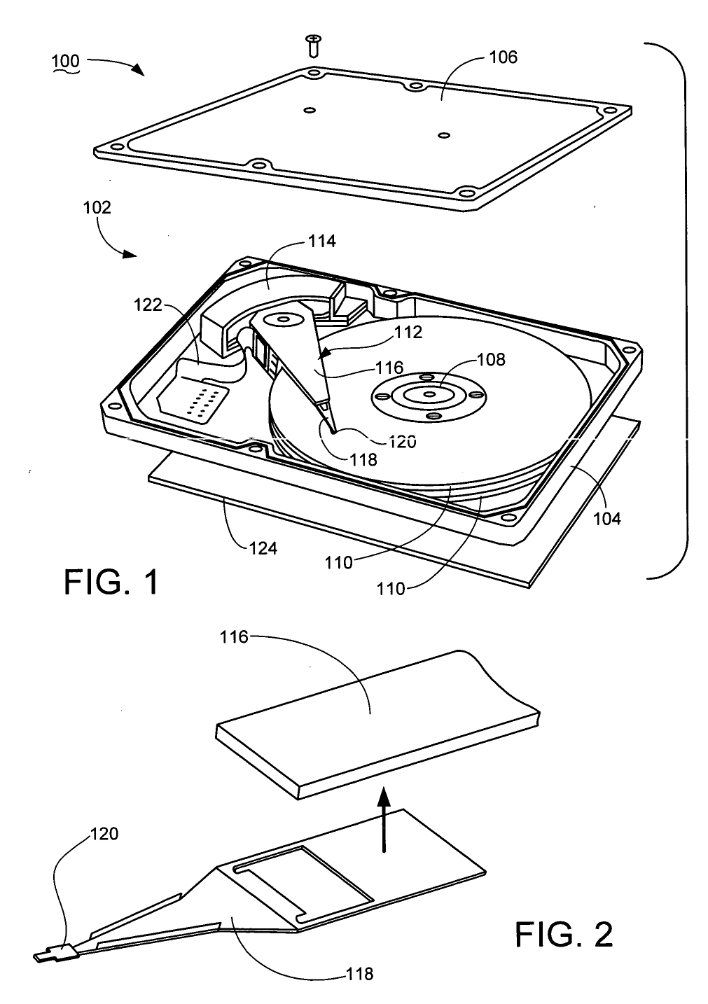

To provide an exemplary environment in which preferred embodiments of the present invention can be advantageously practiced, FIG. 1 provides an exploded view of a data storage device 100 of the type configured to store and retrieve computerized data.

An environmentally controlled housing 102 is formed from a base deck 104 and a top cover 106. A spindle motor 108 is mounted within the housing 102 to rotate a number of magnetic data storage media 110 (in this case, two) at a relatively high speed.

An actuator 112 is rotated by an actuator motor 114, preferably characterized as a voice coil motor (VCM). A plurality of rigid actuator arms 116 project from the actuator 112 toward the media 110 as shown. Suspensions 118 (flexures) extend from the actuator arms 116 to support data transducers 120 adjacent recording surfaces of the media 110.

A flex circuit assembly 122 establishes electrical communication paths between the actuator 112 and an externally mounted printed circuit board (PCB) 124. The PCB 124 supports various circuits and connectors (not separately shown) to facilitate control of the device 100 and communication with a host.

It is contemplated that the device 100 is fabricated in an automated manufacturing environment wherein hundreds, or even thousands, of nominally identical devices are produced each day. Such manufacturing is preferably carried out by conveying pallets to a series of automated assembly stations which sequentially assemble the devices to final form.

Various components are preferably attached together using adhesive during the assembly process, such as the suspensions 118 and the actuator arms 116 as generally depicted in FIG. 2. Other components can be advantageously adjoined using adhesive as well, including the transducers 120 to the suspensions 118, the flex circuit assembly 122 to the base deck 102, bearing assemblies (not numerically designated) used to support rotational movement of the actuator 112, etc.

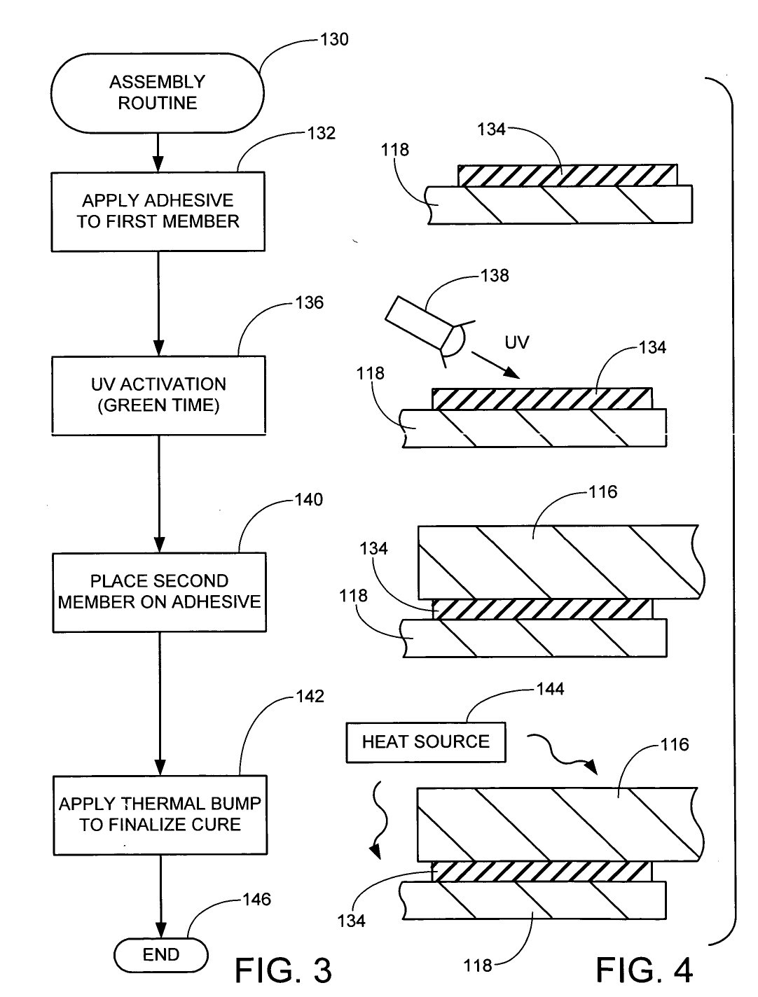

Accordingly, FIG. 3 provides a flow chart for an ASSEMBLY ROUTINE 130, illustrative of steps carried out in accordance with preferred embodiments of the present invention to attach a first member to a second member. FIG. 4 provides a sequence of views corresponding to the various steps of FIG. 3 using the arm 116 and suspension 118 of FIG. 2 as an illustrative example.

At step 132, a layer of adhesive is initially applied to the first member. This adhesive is denoted in FIG. 4 at 134, and is shown to be applied to the suspension assembly 118. However, this is merely for purposes of discussion, as the adhesive could alternatively be initially applied to the actuator arm 116, as desired.

The adhesive 134 is preferably characterized as a non-aromatic, flexible, non-chain linear epoxy (with no cross-linking). As explained below, the adhesive formulation further preferably comprises a super acid catalyst and a photo initiator which enhance the polymerization (curing) process. A suitable fluorescent agent can also be added to the adhesive formulation as desired. Suitable formulations can be commercially obtained from a number of sources, such as The Henkel Group, Düsseldorf, Germany.

The adhesive 134 is preferably selected to have a glass transition temperature (Tg) that is significantly lower than the specified operating/storage temperature requirement range for the application. For example, it is contemplated that the device 100 has a specified temperature requirement range of 5° C. to 85° C. The Tg for the adhesive is preferably selected to be substantially below this range, such as −25° C.

As those skilled in the art will recognize, Tg refers to a temperature at which a polymer transitions from a generally viscous (rubber) state to a solid, amorphous (glass) state. The Tg can vary widely for different types of polymers, and the transition from rubber to glass is often gradual rather than being more sharp in character.

For reference, the applied adhesive 134 in FIG. 4 is shown to have a substantially uniform thickness on the first member. While the operation of step 132 can result in this configuration, it is contemplated that the adhesive 134 may alternatively be applied as one or more localized dots that are subsequently “squashed” to provide a final substantially uniform thickness between the first and second members.

Continuing with the flow of FIG. 3, UV activation of the adhesive 134 next preferably takes place at step 136 in order to initiate the curing process. This is preferably carried out by exposing the adhesive 134 to ultraviolet (UV) radiation from a UV source 138. For formulations such as described above, this will result in the start of a “green time,” or reasonably short period of time (e.g., 5 minutes) during which the adhesive can be mated with the second member, such as at step 138.

After placement of the second member (actuator arm 116) onto the adhesive 134, the flow of FIG. 3 preferably continues at step 142 with the application of heat to the adhesive 134 in order to accelerate and finalize the adhesive cure. This heat is shown to be provided by a suitable heat source 144, such as a source of convected hot air or radiant heat source.

The operation of step 142 is preferably referred to as the application of a “thermal bump,” since the attained temperature of the adhesive is generally lower than that required for a conventional thermal set (e.g., on the order of perhaps 300° C. as opposed to perhaps 500° C. or more). The adhesive 134 and the members 116, 118 are allowed to return to ambient temperature and the adhesive substantially achieves a finalized cured state, at which point the process ends at step 146.

It is contemplated in some embodiments that under normal circumstances, the first member and the second member will remain attached pursuant to the routine of FIG. 3 for the operational life of the combination.

However, under certain circumstances it may be desirable at a later point to subsequently detach the first and second members, either as a result of the desired operation of the members, or to facilitate repairs or other rework type operations. For example, during the aforedescribed manufacturing process it may be determined that a particular data transducer 120 is inoperative. While in some environments it may make economic sense to simply discard the entire actuator 112, in other environments it may be desirable to remove the offending transducer and reattach a new substitute slider/transducer assembly if possible.

Engineering evaluation of new designs, or reliability testing, may also make it desirable to utilize a particular actuator arm while attaching different styles or types of suspensions thereto. This is also true for other combinations of members besides the arms 116 and suspensions 118 discussed herein.

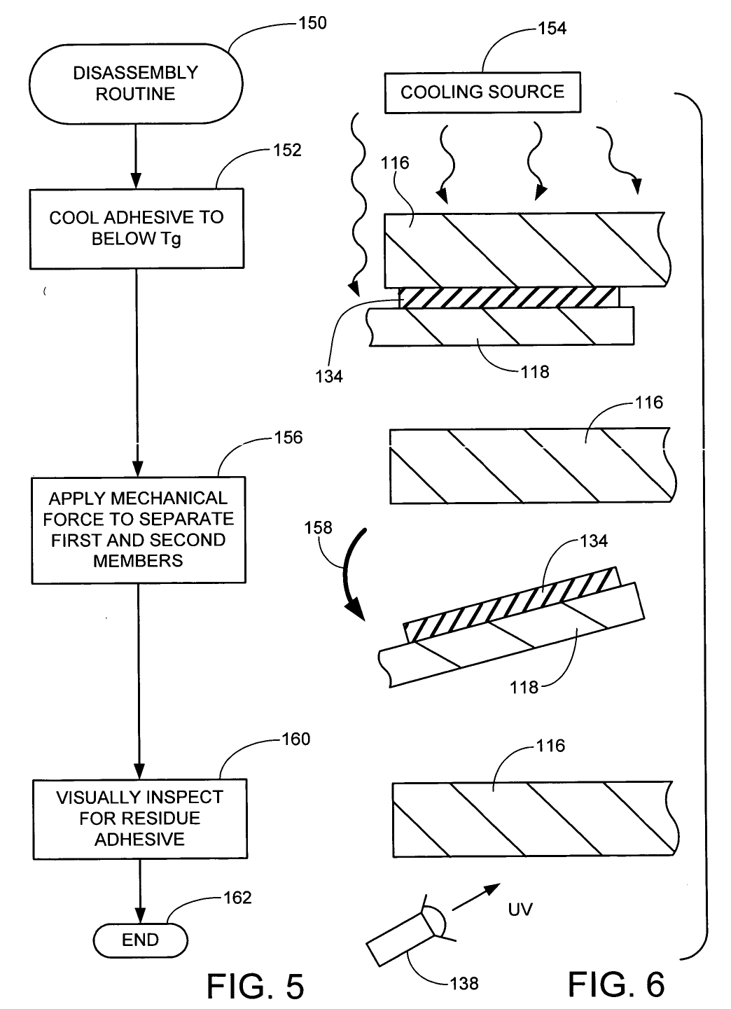

Accordingly, FIG. 5 provides a DISASSEMBLY ROUTE 150 illustrative of steps carried out in accordance with preferred embodiments of the present invention to subsequently detach the first and second members. As before, FIG. 6 provides a sequence of views that correspond to the steps set forth in FIG. 5.

At step 152, the adhesive 134 is locally cooled to a temperature that is below the selected Tg of the adhesive. This is preferably carried out using a suitable cooling source 154 as shown in FIG. 6, such as a vortex chiller, a hand held spot chiller, a cryogenic mini-gun, etc.

Preferably, the cooling source 154 supplies a low temperature fluid (e.g., chilled air) across the adhesive/members and heat is transferred from the adhesive/members to this fluid to lower the temperature of the adhesive 134. The temperature of the adhesive 134 is preferably lowered to as low a temperature as practical without inducing damage to the members or surrounding elements of the device 100 (e.g., −100° C., etc.).

Once cooled to a temperature below the Tg, the adhesive 134 will have transitioned to an amorphous (glass) state, and will be characteristically brittle. Application of a mechanical force (such as depicted by vector 158 in FIG. 6) will thus result in a relatively easy detachment of the respective members.

An optional inspection of the members can next take place at step 160. The inclusion of the aforementioned fluorescent agent into the adhesive formulation allows application of UV light (such as by the source 138) to facilitate detection of the extent to which residual adhesive is left on the members. The flow then ends at step 162.

Depending on the adhesive formulation, the mechanical force 158 applied at step 156 may be only 5-10% of the force normally required to detach the first and second members under ambient conditions. This advantageously reduces stresses or other effects that may deform one or both members. For example, particular characteristics of actuator arms such as 116 can be highly controlled (angle, flatness, Z axis height, etc.), and so it may be desirable to not affect these characteristics during the routine of FIG. 5 in order to allow reuse of the arm.

Along these lines, the respective mating surfaces of the first and second members are preferably provided with different adhesive coupling characteristics. By increasing the tendency of the adhesive to be affixed to one of the members as compared to the other, substantially all of the adhesive can be removed from one of the members and retained on the other, such as depicted in FIG. 6.

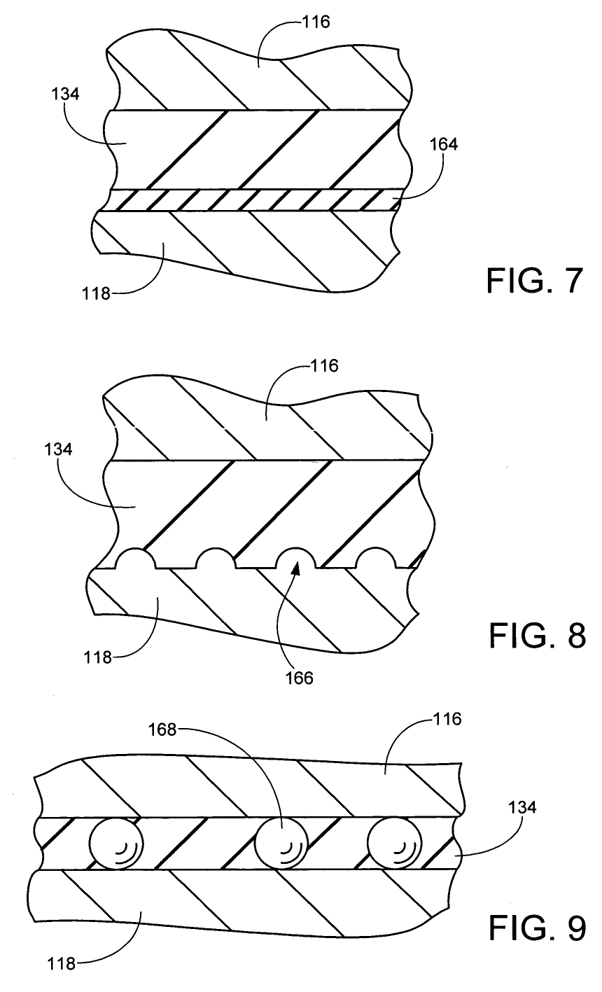

FIG. 7 shows the application of a surface adhesive promotor 164 to only one member (in this case, the suspension 118). The material 164 can take any number of forms, such as a silane agent, and acts as a “primer” coat for the adhesive 134. In FIG. 8, a micro-texturized pattern 166, such as a series of detents, is applied to only one member (suspension 118) to enhance the adhesion of the adhesive 134 to this member as compared to the other member.

Alternatively, or additionally, an inert filler material can be added to the adhesive 134, such as a quantity of glass balls 168 as shown in FIG. 9. The filler material generally establishes a desired separation distance between the first and second members 116, 118, and hence, controls the thickness of the adhesive 134. The filler material further advantageously helps to maintain the structural unity of the adhesive 134 upon detachment of the first and second members 116, 118.

Preferably, a relatively small amount of the filler material is provided, such as on the order of a 5-10% volume fill. The filler material can be initially mixed in with the adhesive 134 so that both the adhesive and the filler material are concurrently applied to the first member (step 132 in FIG. 3). Alternatively, the adhesive can be applied to the first member, and then the filler material can be deposited prior to the mating of the second member (i.e., prior to step 140).

The various preferred embodiments presented herein provide certain advantages over the prior art. The adhesive 134 is particularly suited to automated assembly lines and eliminates the need for off-line processing, curing ovens, and other requirements that might impact high volume manufacturing environments. The cooling of the adhesive 134 to below the Tg allows controlled detachment of the first and second members, and reduces deformation or other damage to the members during the detachment process.

Selective configuration of the respective members further facilitates controlled removal of the adhesive so that, as desired, substantially all of the adhesive is removed from one member (which can be reused) and retained on the other (which can be discarded). The use of a filler material further controls adhesive thickness, and enhances the ability to retain substantially all of the adhesive on just one of the separated members.

Accordingly, the various preferred embodiments presented herein can be advantageously used in a wide variety of applications, such as where a relatively high bond strength is desired for a given operational range, and the members can be subsequently separated at a significantly lower bond strength at a temperature below this operational range.

While a cooling source has been disclosed in preferred embodiments to actively drop the temperature of the adhesive to a temperature well below “ambient room temperature” conditions (e.g., 20° C.), such is not necessarily required. For example, in other applications, the operational range may be sufficiently high such that passive cooling of the adhesive to a given ambient temperature may be sufficient to place the adhesive below the glass transition temperature and in a state suitable for detachment of the members.

It will now be understood that preferred embodiments of the present invention are generally directed to an apparatus and method for attaching and subsequently detaching a first member to a second member.

In accordance with preferred embodiments, the method preferably comprises steps of using (such as by steps 132, 140) an adhesive (such as 134) to attach a first member (such as 118) to a second member (such as 116), and subsequently cooling (such as by step 152) the adhesive to a temperature below a glass transition temperature of the adhesive to detach the first and second members.

Preferably, the using step comprises applying the adhesive to the first member (such as by step 132), exposing the adhesive to ultraviolet light (such as by 138) to initiate curing of the adhesive (such as by step 136), placing the second member onto the adhesive (such as by step 140), and applying heat to the adhesive to finalize curing of the adhesive (such as by step 142).

The method further preferably comprises applying (such as by step 156) a mechanical force (such as 158) to at least a selected one of the first and second members while the adhesive is at said temperature below the glass transition temperature to detach the first and second members.

The method further preferably comprises selectively configuring respective mating surfaces of the first and second members with different adhesive coupling characteristics, such as through the use of a surface adhesive promotor (such as 164) or a micro-texturized pattern (such as 166) to only one of the members. A filler material (such as 168) can also be utilized to control thickness and enhance structural unity of the adhesive.

The method further preferably comprises applying an ultraviolet light (such as by 138) to at least a selected one of the detached first and second members to assess an extent to which the adhesive adhered to said first and second members after the cooling step.

Preferably, a selected one of the first and second members comprises an actuator arm (such as 116) and wherein the remaining one of the first and second members comprises a suspension assembly (such as 118) which supports a data transducer (such as 120). Alternatively, a selected one of the first and second members comprises a suspension assembly (such as 118) and the remaining one of the first and second members comprises a data transducer (such as 120).

In accordance with further preferred embodiments, the apparatus comprises a first member (such as 118), a second member (such as 116), and an adhesive (such as 134) which attaches the first member to the second member, wherein the first member, the second member and the adhesive are respectively configured so that, upon subsequent cooling of the adhesive below a glass transition temperature of the adhesive and detachment of the first and second members, substantially all of the adhesive is removed from a selected one of the first and second members and retained on the remaining one of the first and second members (such as in FIG. 6).

As before, respective mating surfaces of the first and second members are preferably configured with different adhesive coupling characteristics, such as through the use of a surface adhesive promotor (such as 164) or a micro-texturized pattern (such as 166) to only one of the members. A filler material (such as 168) can also be utilized to control thickness and enhance structural unity of the adhesive.

For purposes of the appended claims, the recited steps for attaching and for detaching the first and second members will be understood to correspond to the disclosed routines 130 and 150 of FIGS. 3 and 5.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising steps of using an adhesive to attach a first member to a second member, and subsequently cooling the adhesive to a temperature below a glass transition temperature of the adhesive to detach the first and second members.

2. The method of claim 1, further comprising a step of applying a mechanical force to at least a selected one of the first and second members while the adhesive is at said temperature below the glass transition temperature to detach the first and second members.

3. The method of claim 1, further comprising a prior step of selectively configuring respective mating surfaces of the first and second members with different adhesive coupling characteristics.

4. The method of claim 1, further comprising a prior step of applying a surface adhesive promotor to only the first member so that, upon detachment of the first and second members, substantially all of the adhesive is removed from the second member and retained on the first member.

5. The method of claim 1, further comprising a prior step of providing a micro-texturized pattern to only the first member so that, upon detachment of the first and second members, substantially all of the adhesive is removed from the second member and retained on the first member.

6. The method of claim 1, wherein the adhesive of the using step comprises a non-aromatic, flexible, non-chain linear epoxy with a super acid activator and a photo initiator.

7. The method of claim 6, wherein the adhesive further comprises a fluorescent agent.

8. The method of claim 1, wherein the using step comprises providing a filler material to the adhesive to establish a separation distance between the first and second members and to enhance structural unity of the adhesive during detachment of said members.

9. The method of claim 1, wherein the using step comprises applying the adhesive to a selected one of the first and second members, exposing the adhesive to ultraviolet light to initiate curing of the adhesive, placing the remaining one of the first and second members onto the adhesive, and applying heat to the adhesive to finalize curing of the adhesive.

10. The method of claim 1, further comprising a step of applying an ultraviolet light to at least a selected one of the detached first and second members to assess an extent to which the adhesive adhered to said first and second members after the cooling step.

11. The method of claim 1, wherein a selected one of the first and second members comprises an actuator arm and wherein the remaining one of the first and second members comprises a suspension assembly which supports a data transducer.

12. The method of claim 1, wherein a selected one of the first and second members comprises a suspension assembly and the remaining one of the first and second members comprises a data transducer.

13. An apparatus comprising a first member, a second member and an adhesive which attaches the first member to the second member, wherein the first member, the second member and the adhesive are respectively configured so that, upon subsequent cooling of the adhesive below a glass transition temperature of the adhesive and detachment of the first and second members, substantially all of the adhesive is removed from a selected one of the first and second members and retained on the remaining one of the first and second members.

14. The apparatus of claim 13, further comprising a surface adhesive promotor applied to the first member and not to the second member.

15. The apparatus of claim 13, wherein the first member comprises a micro-texturized pattern and the second member does not comprise a micro-texturized pattern.

16. The apparatus of claim 13, wherein the adhesive of the using step comprises a non-aromatic, flexible, non-chain linear epoxy with a super acid activator and photo initiator.

17. The apparatus of claim 16, wherein the adhesive further comprises a fluorescent agent configured to provide a visual indication of an extent to which adhesive remains on at least a selected one of the detached first and second members.

18. The apparatus of claim 16, wherein the first and second members are selected from a group consisting essentially of an actuator arm, a suspension, and a data transducer.

19. The apparatus of claim 13, further comprising a filler material which establishes a separation distance between the first and second members and enhances structural unity of the adhesive upon detachment of the first and second members.

20. An apparatus comprising a first member, a second member and an adhesive, whereby the first and second members are attached and subsequently detached by steps for attaching and for detaching the first and second members.
